(19) United States
(12) Patent Application Publication
(10) Pub. No.: US 2022/0213943 A1
(43) Pub. Date: Jul. 7, 2022

(54) SPRING GUIDE AND SUSPENSION DEVICE

(71) Applicant: KYB Corporation, Tokyo (JP)

(72) Inventor: Kenta KURIHARA, Aichi (JP)

(73) Assignee: KYB Corporation, Tokyo (JP)

(21) Appl. No.: 17/606,261

(22) PCT Filed: Apr. 27, 2020
(86) PCT No.: PCT/JP2020/017970

§ 371 Date: Oct. 25, 2021

(30) Foreign Application Priority Data
May 21, 2019 (JP) 2019-095069
Sep. 26, 2019 (JP) 2019-175848

(51) Int. Cl. F16F 9/32; B60G 11/16

(52) U.S. Cl. CPC F16F 9/3207; F16F 1/12; B60G 11/16

(57) ABSTRACT

A spring guide attached to a shock absorber, the shock absorber being provided between a vehicle body and a wheel, the spring guide being configured to support a coil spring for elastically supporting the vehicle body, and the spring guide includes: a main body portion formed of a resin material; and an elastic part provided between the main body portion and an end portion of the coil spring, the elastic part is formed of a material having elastic modulus lower than the material forming the main body portion, the elastic part being integrally molded on the main body portion.

### TECHNICAL FIELD

The present invention relates to a spring guide and a suspension device.

### BACKGROUND ART

A suspension device provided with a shock absorber, a coil spring that is provided outside the shock absorber, and a spring guide that supports a lower end portion of the coil spring has been known (see JP2012-219825A). The spring guide has a metallic spring receiving member and a rubber sheet that is provided between the spring receiving member and the lower end portion of the coil spring.

The rubber sheet is provided with two aligning protrusions for aligning the rubber sheet with respect to the spring receiving member. The rubber sheet is installed to the spring receiving member by fitting the respective protruded portions to aligning holes provided in the spring receiving member.

### SUMMARY OF INVENTION

In the suspension device described in JP2012-219825A, the spring receiving member forming the spring guide and the rubber sheet are separate parts. Therefore, the rubber sheet needs to be installed to the spring receiving member, and it takes time and labor for assembly thereof. In addition, there have been increasing demands for reducing weight of devices to be mounted on vehicles such as an automobile, etc. Therefore, there is a demand for reducing weight of the spring guide.

An object of the present invention is to reduce weight of a spring guide and to reduce a number of parts constituting the spring guide.

According to one aspect of the present invention, a spring guide attached to a shock absorber, the shock absorber being provided between a vehicle body and a wheel, the spring guide being configured to support a coil spring for elastically supporting the vehicle body, and the spring guide includes: a main body portion formed of a resin material; and an elastic part provided between the main body portion and an end portion of the coil spring, the elastic part is formed of a material having elastic modulus lower than the material forming the main body portion, the elastic part being integrally molded on the main body portion.

### BRIEF DESCRIPTION OF DRAWINGS

FIG. 1 is a partial sectional view of a suspension device according to a first embodiment of the present invention.

FIG. 2 is a perspective view of the spring guide according to the first embodiment of the present invention.

FIG. 3A is a schematic plan view of the spring guide according to the first embodiment of the present invention as viewed from above, the schematic plan view showing a shape of the spring guide in a simplified form and schematically showing a region in which an elastic part is formed with a hatched pattern.

FIG. 3B is a side sectional view of the spring guide according to the first embodiment of the present invention.

FIG. 4A is a schematic plan view of the spring guide according to a modification of the first embodiment of the present invention as viewed from above, the schematic plan view showing a shape of the spring guide in a simplified form and schematically showing a region in which an elastic part is formed with a hatched pattern.

FIG. 4B is a side sectional view of the spring guide according to the modification of the first embodiment of the present invention.

FIG. 5A is a schematic plan view of the spring guide according to a second embodiment of the present invention as viewed from above, the schematic plan view showing a shape of the spring guide in a simplified form and schematically showing a region in which an elastic part is formed with a hatched pattern.

FIG. 5B is a side sectional view of the spring guide according to the second embodiment of the present invention.

FIG. 6A is a schematic plan view of the spring guide according to a modification of the second embodiment of the present invention as viewed from above, the schematic plan view showing a shape of the spring guide in a simplified form and schematically showing a region in which an elastic part is formed with a hatched pattern.

FIG. 6B is a side sectional view of the spring guide according to the modification of the second embodiment of the present invention.

FIG. 7A is a schematic plan view of the spring guide according to a third embodiment of the present invention as viewed from above, the schematic plan view showing a shape of the spring guide in a simplified form and schematically showing a region in which an elastic part is formed with a hatched pattern.

FIG. 7B is a side sectional view of the spring guide according to the third embodiment of the present invention.

FIG. 8A is a schematic plan view of the spring guide according to a modification of the third embodiment of the present invention as viewed from above, the schematic plan view showing a shape of the spring guide in a simplified form and schematically showing a region in which an elastic part is formed with a hatched pattern.

FIG. 8B is a side sectional view of the spring guide according to the modification of the third embodiment of the present invention.

FIG. 9A is a schematic plan view of the spring guide according to a fourth embodiment of the present invention as viewed from above, the schematic plan view showing a shape of the spring guide in a simplified form and schematically showing a region in which an elastic part is formed with a hatched pattern.

FIG. 9B is a side sectional view of the spring guide according to the fourth embodiment of the present invention.

FIG. 10A is a schematic plan view of the spring guide according to a modification of the fourth embodiment of the present invention as viewed from above, the schematic plan view showing a shape of the spring guide in a simplified form and schematically showing a region in which an elastic part is formed with a hatched pattern.

FIG. 10B is a side sectional view of the spring guide according to the modification of the fourth embodiment of the present invention.

FIG. 11A is a schematic plan view of the spring guide according to a first modification of this embodiment as viewed from above, the schematic plan view showing a shape of the spring guide in a simplified form and schematically showing a region in which an elastic part is formed with a hatched pattern.

FIG. 11B is a side sectional view of the spring guide according to the first modification of this embodiment.

FIG. 12A is a schematic plan view of the spring guide according to a second modification of this embodiment as viewed from above, the schematic plan view showing a shape of the spring guide in a simplified form and schematically showing a region in which an elastic part is formed with a hatched pattern.

FIG. 12B is a side sectional view of the spring guide according to the second modification of this embodiment.

FIG. 13 is a side sectional view of the spring guide according to a third modification of this embodiment.

FIG. 14 is a partial sectional view of a vicinity of a lip of the spring guide according to a fifth modification of this embodiment.

### DESCRIPTION OF EMBODIMENTS

A suspension device 10 according to an embodiment of the present invention will be described with reference to the drawings.

The suspension device 10 is a device that is installed on an automobile (not shown) for stably suspending a vehicle body by positioning a wheel (not shown) and by generating a damping force so as to absorb impacts and vibrations received from a road surface during a travelling of a vehicle.

### First Embodiment

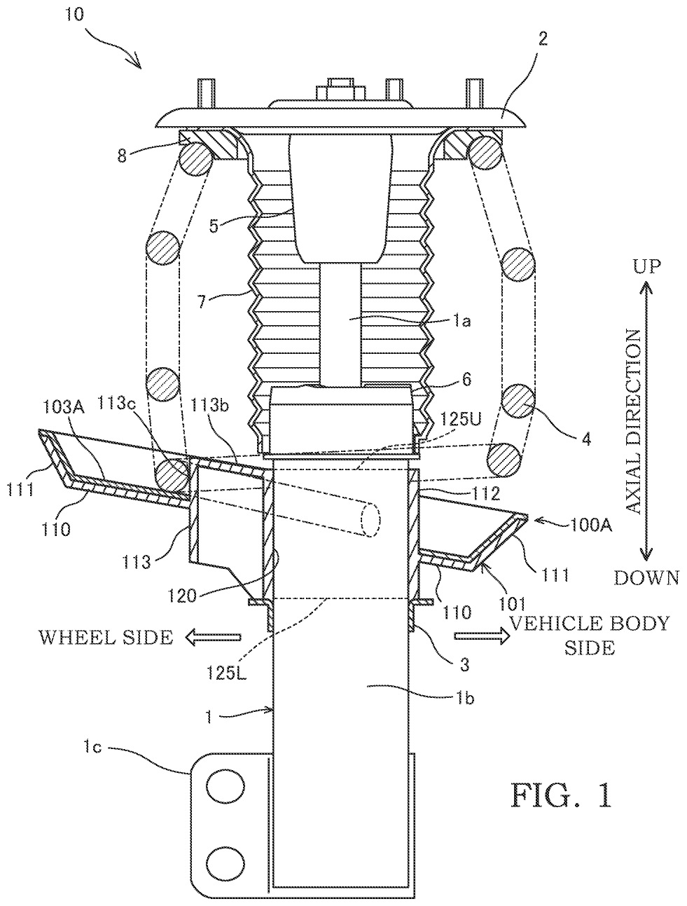

The suspension device 10 according to a first embodiment of the present invention will be described with reference to FIGS. 1, 2, 3A, and 3B. FIG. 1 is a partial sectional view of the suspension device 10. As shown in FIG. 1, the suspension device 10 is provided with: a shock absorber 1 that is provided between the vehicle body and the wheel; an upper mount 2 that is attached to a tip end of a piston rod (hereinafter, referred to as a rod) 1a of the shock absorber 1; a spring guide 100A attached to an outer circumference of a cylinder 1b of the shock absorber 1; a coil spring 4 that is provided between the spring guide 100A and the upper mount 2 and that elastically supports the vehicle body; a bump cushion 5 that is fitted to a rod 1a and that restricts a stroke of the shock absorber 1 in a contracting direction; a bump stopper 6 that is fitted to an end portion of the cylinder 1b on the side of the rod 1a; and a tubular dust boot 7 that protects the rod 1a.

The shock absorber 1 has the cylinder 1b and the columnar rod 1a that projects out from an opening of the cylinder 1b. The shock absorber 1 is a twin-tube shock absorber, and the cylinder 1b has an outer tube having a bottomed cylindrical shape forming an outer hull of the cylinder 1b and an inner tube (not shown) that is provided on the inner side of the outer tube. A piston (not shown) is linked to a lower end portion of the rod 1a for dividing an interior of the inner tube (not shown) into an extension-side chamber and a contraction-side chamber.

An end portion of the cylinder 1b on the opposite side from the rod 1a side is provided with a knuckle bracket 1c that links the shock absorber 1 and a knuckle (not shown) for holding the wheel. For the sake of convenience of description, the vertical direction is stated as illustrated in the figure such that the upper mount 2 side corresponds to the upper side of the suspension device 10 and the knuckle bracket 1c side corresponds to the lower side of the suspension device 10. The vertical direction of the suspension device 10 corresponds to the axial direction (the center axial direction) of the suspension device 10 and to the extending/contracting direction of the shock absorber 1. In addition, the radial direction of the suspension device 10 (the radial direction of the shock absorber 1) is orthogonal to the axial direction of the suspension device 10.

The shock absorber 1 is assembled to the vehicle by being linked to the vehicle body via the upper mount 2 and by being linked to the knuckle by the knuckle bracket 1c. The shock absorber 1 configured as described above is configured so as to generate the damping force when the rod 1a is moved in the axial direction (the vertical direction in FIG. 1) relative to the cylinder 1b. The suspension device 10 quickly attenuates the vibrations of the vehicle body by the damping force generated by the shock absorber 1.

The coil spring 4 is provided between the spring guide 100A and the upper mount 2. The coil spring 4 is sandwiched by the spring guide 100A and the upper mount 2 in a compressed state, thereby biasing the shock absorber 1 in the extending direction.

A rubber sheet 8 is provided between the upper mount 2 and an upper end portion the coil spring 4. With such a configuration, the upper mount 2 is prevented from coming into direct contact with the coil spring 4. An elastic part 103A, which will be described below, is provided between a main body portion 101 of the spring guide 100A and lower end portion of the coil spring 4. With such a configuration, the main body portion 101 of the spring guide 100A is prevented from coming into direct contact with the coil spring 4.

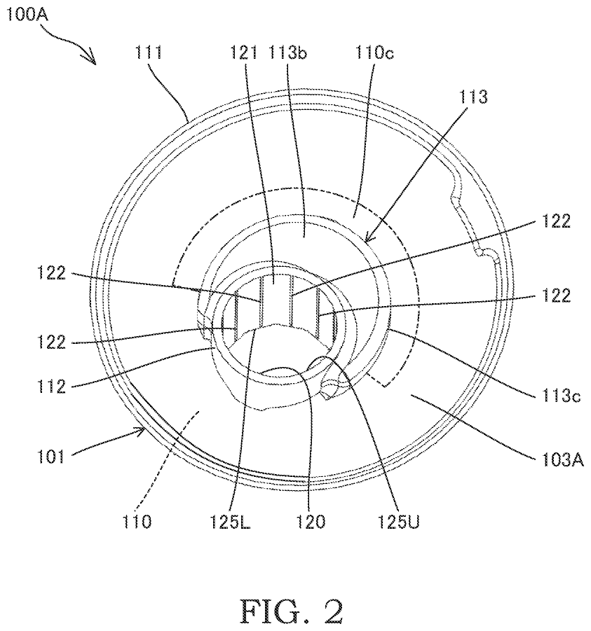

FIG. 2 is a perspective view of the spring guide 100A. As shown in FIGS. 1 and 2, the spring guide 100A is a member that is attached to the outer circumference of the cylinder 1b to support the coil spring 4 from the below. The spring guide 100A has the main body portion 101 formed of a resin material and the elastic part 103A that is integrally molded on an upper surface of the main body portion 101.

The main body portion 101 of the spring guide 100A is provided with: a disc-shaped base portion 110 on which the lower end portion of the coil spring 4 is mounted; a cylindrical tube portion 112 that is formed so as to project upwards and downwards from the base portion 110; a side wall 111 that extends upwards at an incline from a radially-outside end portion of the base portion 110; and a hub 113 that is provided on the outer circumferential side of the tube portion 112. The side wall 111 has an annular shape and is inclined such that the inner diameter is increased towards the upper side from the base portion 110.

As shown in FIG. 2, the base portion 110 has a mounting region 110c that is set around the hub 113 of the spring guide 100A. The mounting region 110c is an arc-shaped region on which the lower end portion of the coil spring 4 is mounted. An angle range of the mounting region 110c is set at an arbitrary angle of 180 degree or more.

The tube portion 112 has an insertion hole 120 that penetrates through the tube portion 112 in the axial direction of the suspension device 10 (the vertical direction) and through which the cylinder 1b of the shock absorber 1 is inserted. As shown in FIG. 1, the insertion hole 120 is formed at a position decentered from the center of the spring guide 100A towards the side of the vehicle body when the spring guide 100A is attached to the outer circumference of the cylinder 1b.

As shown in FIG. 2, the insertion hole 120 is provided with ribs 122 serving as projected portions that are projected radially inward from an inner circumferential surface 121 of the insertion hole 120. The ribs 122 function as supporting portions that support an outer circumferential surface of the cylinder 1b of the shock absorber 1. The respective ribs 122 are provided so as to extend linearly along the axial direction of the insertion hole 120 (in other words, the axial direction of the suspension device 10).

The ribs 122 are each formed so as to have, for example, a rounded trapezoidal cross-sectional shape or a semicircular cross-sectional shape, and the ribs 122 come into line contact with the outer circumferential surface of the cylinder 1b. A plurality of ribs 122 are arranged at equal intervals along the circumferential direction of the insertion hole 120. Therefore, the spring guide 100A is aligned such that the center axis of the insertion hole 120 coincides with the center axis of the cylinder 1b.

The fitting between the cylinder 1b and the insertion hole 120, specifically, the fitting between the cylinder 1b and the ribs 122 formed in the insertion hole 120 (see FIG. 2) may be “a clearance fitting” or “an interference fitting”. By employing “the interference fitting”, rattling between the insertion hole 120 and the cylinder 1b is prevented, and so, it is possible to prevent generation of noise due to the rattling. In addition, it is also possible to improve responsibility of the operation of the suspension device 10.

As shown in FIG. 1, a metallic support ring 3 is fixed to the outer circumferential surface of the cylinder 1b by being welded. The support ring 3 serves as a supporting portion for supporting the spring guide 100A. The supporting portion may be formed by expanding the cylinder 1b without providing the support ring 3. The spring guide 100A is fixed to the outer circumference of the cylinder 1b by fitting the insertion hole 120 to the outer circumference of the cylinder 1b such that a lower end portion of the tube portion 112 of the spring guide 100A is supported by the support ring 3.

The spring guide 100A is attached to the cylinder 1b by being fitted to the cylinder 1b from the above so as to come into contact with the support ring 3. In other words, the cylinder 1b is inserted from a lower opening end 125L of the insertion hole 120 of the spring guide 100A. In other words, the lower opening end 125L is an entrance from which the cylinder 1b is inserted, and an upper end portion of the cylinder 1b is projected out from an upper opening end 125U that is an opening end on the opposite side from the lower opening end 125L.

The hub 113 is provided so as to project upward from the base portion 110 at inside the coil spring 4. The hub 113 has a bottomed cylindrical shape in which an upper portion 113b forms a bottom portion and an opening is formed on a lower portion. In order to increase rigidity of the hub 113, a plurality of ribs are provided on the inner side of a tube portion 113c of the hub 113. An outer circumference of the tube portion 113c of the hub 113 comes into contact with an inner circumference of the lower end portion of the coil spring 4, thereby defining the position of the coil spring 4 in the radial direction. In other words, the hub 113 functions as a position defining part that defines the position of the lower end portion of the coil spring 4. Because the lower end portion of the coil spring 4 is held by the hub 113, an inclination (loss of perpendicularity) of the coil spring 4 is prevented.

The elastic part 103A is formed of a material having elastic modulus that is lower than that of the resin material forming the main body portion 101 and is integrally molded with the main body portion 101 formed of the resin. As the material forming the elastic part 103A, thermoplastic elastomers such as polyester elastomers, polyurethane elastomers, polyolefin elastomers, silicone elastomers, and so forth are employed. The material forming the elastic part 103A is not limited to the thermoplastic elastomers, and thermosetting elastomers such as polyurethane rubber, silicone rubber, fluorocarbon rubber, and so forth may also be employed. Any materials may be employed as the material forming the elastic part 103A as long as the material at least has the elastic modulus that is lower than that of the resin material forming the main body portion 101. It is not limited to the elastomers, and the resin material may also be employed.

The elastic part 103A is integrally molded on the main body portion 101 by using, for example, a two color molding. Although a material forming the main body portion 101 and a material forming the elastic part 103A can be selected from various materials, it is preferable that the selection be performed in consideration of a combination of the materials that achieves a higher bonding strength between the material forming the main body portion 101 and the material forming the elastic part 103A.

The spring guide described in JP2012-219825A has the configuration in which, when the rubber sheet is to be installed to the spring receiving member the rubber sheet is aligned by fitting the protruded portions thereof into the holes of the spring receiving member. In other words, in the spring guide described in JP2012-219825A, it is required to form recesses and projections for installing the rubber sheet to the spring receiving member. The recesses and projections that are formed on the spring receiving member may cause a bias in the stress acting on the spring receiving member.

In contrast, in this embodiment, because the elastic part 103A is integrally molded with the main body portion 101, and therefore, compared with the related art, it is possible to reduce a number of the recesses and projections on the main body portion 101. As a result, it is possible to reduce the bias in the stress acting on the main body portion 101. In addition, because installation works required when the elastic part 103A is molded separately from the main body portion 101 can be omitted, it is possible to improve workability upon assembly of the suspension device 10.

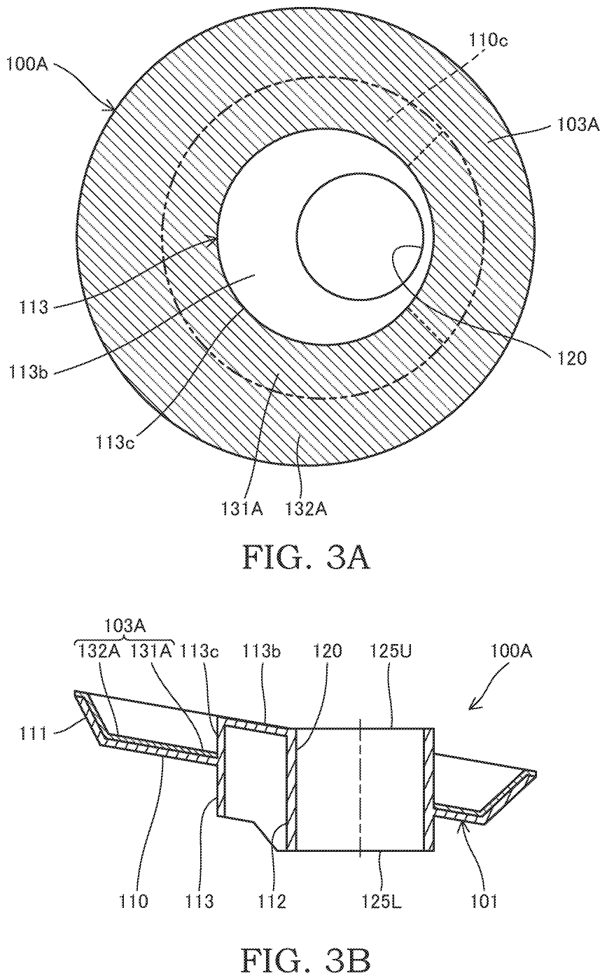

A region in which the elastic part 103A is formed will be described with reference to FIGS. 3A and 3B. FIG. 3A is a schematic plan view of the spring guide 100A as viewed from above, the schematic plan view showing a shape of the spring guide 100A in a simplified form and schematically showing the region in which the elastic part 103A is formed with a hatched pattern. FIG. 3B is a side sectional view of the spring guide 100A.

As shown in FIGS. 3A and 3B, the elastic part 103A is formed so as to cover the entire surface of an upper surface of the base portion 110 including the mounting region 110c and the entire surface of an upper surface (an inner surface) of the side wall 111. The elastic part 103A is formed so as to have a uniform thickness.

In this embodiment, the elastic part 103A is formed on the mounting region 110c. In addition, in this embodiment, the elastic part 103A is formed not only on the mounting region 110c, but also on the entire surface of the upper surface of the base portion 110 excluding the mounting region 110c and on the entire surface of the upper surface (the inner surface) of the side wall 111.

In other words, the elastic part 103A has: a first elastic sheet portion 131A that is integrally molded on an annular-shaped region including the mounting region 110c in the base portion 110; and a second elastic sheet portion 132A that is integrally molded on a radially-outside region of the mounting region 110c in the base portion 110 and on the side wall 111.

Because the first elastic sheet portion 131A is integrally molded on the mounting region 110c, the lower end portion of the coil spring 4 is prevented from coming into direct contact with the main body portion 101. Therefore, wearing of the main body portion 101 is prevented by the lower end portion of the coil spring 4 while the suspension device 10 is repeatedly undergoing the contraction and extension, and it is possible to improve a service life of the spring guide 100A. In addition, when the lower end portion of the coil spring 4 is supported directly by the main body portion 101, a noise may be caused between the lower end portion of the coil spring 4 and the main body portion 101. In contrast, in this embodiment, because the first elastic sheet portion 131A is provided between the lower end portion of the coil spring 4 and the main body portion 101 of the spring guide 100A, it is possible to suppress the generation of the noise.

Furthermore, the second elastic sheet portion 132A is integrally molded on the radially-outside region of the mounting region 110c in the base portion 110 and on the side wall 111. Therefore, in the event of a breakage (a fracture) of the coil spring 4, even if the broken part of the coil spring 4 (for example, a broken part of a fragment scattered at the time of the breakage of the coil spring 4, and in a case in which the coil spring 4 is broken so as to be split into an upper part and a lower part, a broken part of a lower end of the upper coil spring 4) falls and lands on upper surfaces of the base portion 110 and the side wall 111, it is possible to absorb an impact caused by the broken part with the second elastic sheet portion 132A in the elastic part 103A. Thus, the load acting on the main body portion 101 of the spring guide 100A is dissipated. As a result, it is possible to effectively prevent the damage of the base portion 110 and the side wall 111 of the spring guide 100A.

The entire surface of the upper surface of the base portion 110 and the entire surface of the upper surface (the inner surface) of the side wall 111 of the spring guide 100A are covered by the elastic part 103A. With such a configuration, it is also possible to prevent a damage of the main body portion 101 due to a collision of a flying stone, etc., whose colliding position being difficult to predict.

According to the above-described embodiment, following operational advantages are afforded.

In this embodiment, because the main body portion 101 of the spring guide 100A is formed of the resin material, it is possible to achieve weight reduction compared with a case in which the main body portion 101 is formed of a metal material. In addition, the elastic part 103A is integrally molded with the main body portion 101, and thus, the spring guide 100A is configured as a single part. Therefore, compared with a case in which the main body portion 101 and the elastic part 103A are formed individually as separate parts and the elastic part 103A is installed to the main body portion 101 by the fitting, for example, it is possible to reduce a number of parts constituting the spring guide 100A. In other words, with this embodiment, it is possible to reduce the weight of the spring guide 100A, and at the same time, it is possible to reduce the number of parts constituting the spring guide 100A.

As a result, it is possible to provide the suspension device 10 with which the weight reduction is achieved without increasing the number of parts.

### Modification of First Embodiment

In the above-described first embodiment, a description has been given of the spring guide 100A in which the base portion 110 extends toward the outer side of the mounting region 110c in the radial direction and in which the side wall 111 extends upwards at an incline from the radially-outside end portion of the base portion 110 (see FIGS. 2 and 3B); however, the present invention is not limited thereto. It is possible to omit the side wall 111.

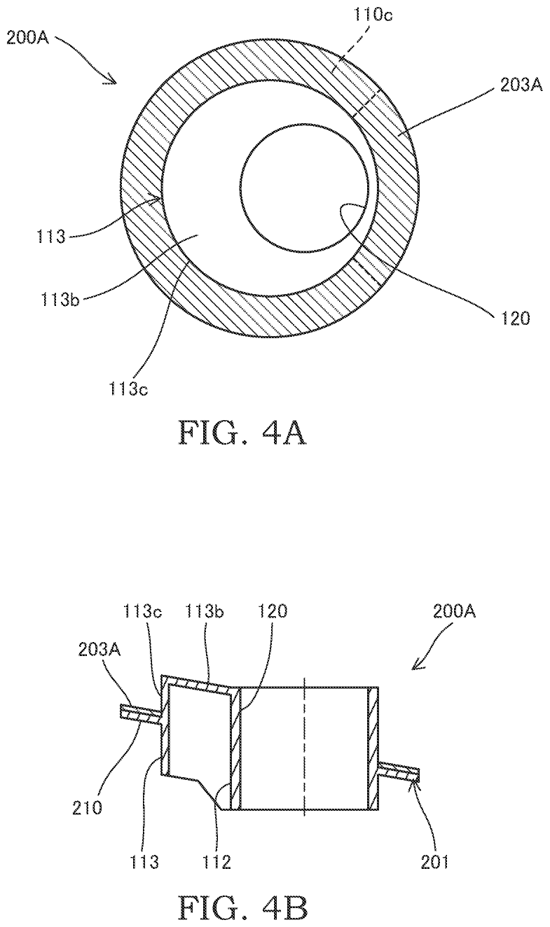

As shown in FIGS. 4A and 4B, in a spring guide 200A according to this modification, a main body portion 201 has a circular base portion 210 having a width (the dimension in the radial direction) that is slightly wider than that of the mounting region 110c. Here, the main body portion 201 does not have the side wall 111, which is described in the first embodiment, at the radially-outside end portion of the base portion 210 (see FIG. 3B). In this modification, an elastic part 203A is formed so as to cover the entire surface of an upper surface of the base portion 210 including the mounting region 110c.

According to this modification, similarly to the above-described first embodiment, it is possible to reduce the number of parts constituting the spring guide 200A. In addition, it is possible to further reduce the weight of the spring guide 200A compared with the above-described first embodiment.

### Second Embodiment

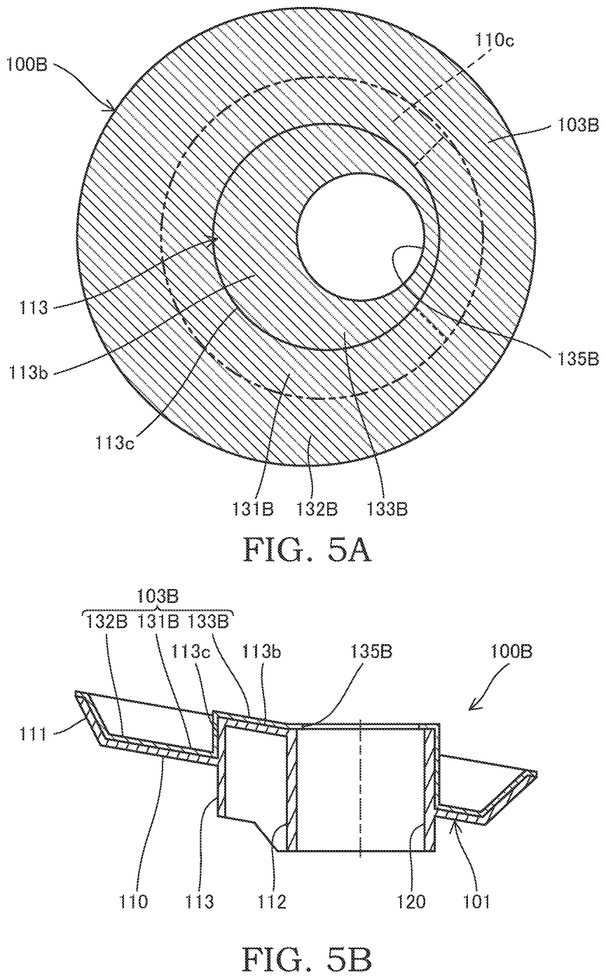

A spring guide 100B according to a second embodiment of the present invention will be described with reference to FIGS. 5A and 5B. In the following, differences from the above-mentioned first embodiment will be mainly described, and in the figures, components that are the same as or correspond to the components described in the above-mentioned first embodiment are assigned the same reference numerals and description thereof will be omitted.

In the above-described first embodiment, the elastic part 103A is integrally molded on the base portion 110 and the side wall 111 (see FIG. 3A, FIG. 3B). In contrast, in this second embodiment, an elastic part 103B is integrally molded not only on the base portion 110 and the side wall 111, but also on the hub 113 and the tube portion 112. The elastic part 103B is formed with a circular through hole 135B, and the cylinder 1b is inserted into the through hole 135B.

The elastic part 103B is formed so as to cover the entire surface of an upper surface of the hub 113 and the entire surface of an upper end surface of the tube portion 112. As described above, in this second embodiment, the elastic part 103B has: a first elastic sheet portion 131B that is integrally molded on the mounting region 110c of the base portion 110; a second elastic sheet portion 132B that is integrally molded on the radially-outside region of the mounting region 110c in the base portion 110 and on the side wall 111; and a third elastic sheet portion 133B that is integrally molded on the hub 113 and the tube portion 112.

The vehicle is used in various environments. For example, in a case in which the vehicle travels in an area with heavy snowfall, the suspension device 10 may come into contact with water containing snow-melting chemicals. The snow-melting chemicals typically contain calcium chloride. Therefore, if water containing calcium chloride enters a gap between the outer circumference of the cylinder 1b and the inner circumference of the insertion hole 120, there is a risk in that the inner circumference of the insertion hole 120 is degraded and damaged.

The through hole 135B formed in the third elastic sheet portion 133B of the elastic part 103B is formed such that the inner circumference portion thereof comes into contact with the outer circumference of the cylinder 1b over its entire circumference. The third elastic sheet portion 133B of the elastic part 103B closes the gap between the cylinder 1b and the insertion hole 120 of the tube portion 112 through which the cylinder 1b is inserted. Therefore, it is possible to prevent extraneous matters such as sand, water, and so forth from entering the gap between the cylinder 1b and the insertion hole 120 by the third elastic sheet portion 133B of the elastic part 103B. As a result, it is possible to prevent the degradation and damage due to the entrance of the extraneous matters into the gap between the outer circumference of the cylinder 1b and the inner circumference of the insertion hole 120.

According to the second embodiment as described above, in addition to the operational advantages similar to those of the first embodiment, following operational advantages are afforded.

The third elastic sheet portion 133B is integrally molded on the hub 113 and the tube portion 112 that are provided on the inner side of the coil spring 4. Therefore, even if the coil spring 4 is broken (fractured) and a part of the broken coil spring 4 falls and lands on the upper surfaces of the hub 113 and the tube portion 112, it is possible to absorb the impact caused by the broken part of the coil spring 4 with the third elastic sheet portion 133B of the elastic part 103B. Thus, the load acting on the main body portion 101 of the spring guide 100B is dissipated. As a result, it is possible to prevent the damage of the hub 113 and the tube portion 112.

In addition, because the entrance of the extraneous matters such as the sand, the water, and so forth into the gap between the cylinder 1b and the insertion hole 120 is prevented by the third elastic sheet portion 133B of the elastic part 103B, it is possible to prevent the degradation and damage of the cylinder 1b.

The third elastic sheet portion 133B of the elastic part 103B also covers the entire surface of an outer circumferential surface of the tube portion 113c of the hub 113 that is positioned between the upper portion 113b of the hub 113 and the base portion 110. With such a configuration, it is possible to suppress the wearing of the outer circumferential surface of the tube portion 113c of the hub 113 by the lower end portion of the coil spring 4.

### Modification of Second Embodiment

In the above-described second embodiment, a description has been given of the spring guide 100B in which the base portion 110 extends toward the outer side of the mounting region 110c in the radial direction and in which the side wall 111 extends upwards at an incline from the radially-outside end portion of the base portion 110 (see FIG. 5B); however, the present invention is not limited thereto. It is possible to omit the side wall 111.

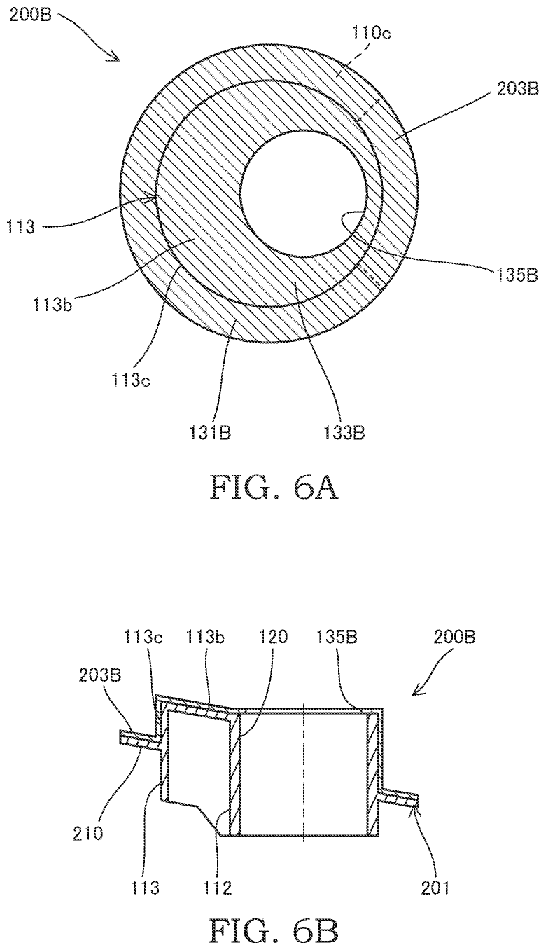

As shown in FIGS. 6A and 6B, in a spring guide 200B according to this modification, in contrast to the main body portion 201 described in the modification of the above-described first embodiment (see FIG. 4B), similarly to the above-described second embodiment, an elastic part 203B is integrally molded on the hub 113 and the tube portion 112.

### Third Embodiment

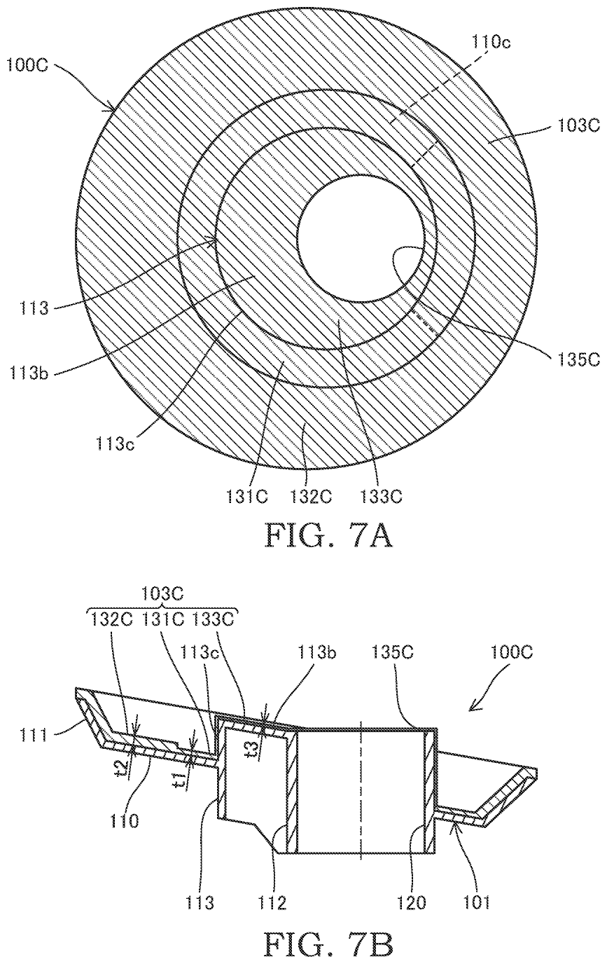

A spring guide 100C according to a third embodiment of the present invention will be described with reference to FIGS. 7A and 7B. In the following, differences from the above-mentioned second embodiment will be mainly described, and in the figures, components that are the same as or correspond to the components described in the above-mentioned second embodiment are assigned the same reference numerals and description thereof will be omitted.

In the above-described second embodiment, the thickness of the elastic part 103B is uniform. In contrast, in the third embodiment, the thickness of an elastic part 103C is not uniform.

When the coil spring 4 is broken, the part of the broken coil spring 4 tends to fall and land on the radially-outside region of the mounting region 110c than on the radially inner side of the mounting region 110c. In addition, when the part of the broken coil spring 4 falls and lands on the spring guide 100C, if a sharp portion of the broken part of the coil spring 4 comes into contact with the spring guide 100C, an excessive impact force may act locally.

Thus, in this embodiment, the thickness t2 of the second elastic sheet portion 132C formed on the radially-outside region of the mounting region 110c is thicker than the thickness t1 of the first elastic sheet portion 131C formed on the mounting region 110c (i.e. t2>t1). With such a configuration, it is possible to absorb the impact caused by the broken part of the coil spring 4 with the second elastic sheet portion 132C in a more suitable manner.

A third elastic sheet portion 133C is formed with a through hole 135C through which the cylinder 1b is inserted, and an inner circumference portion (a radially inner end portion) of the through hole 135C comes into contact with the cylinder 1b. With such a configuration, if the thickness of the third elastic sheet portion 133C is too thick, there is a risk in that, when the spring guide 100C is to be installed to the cylinder 1b, it takes time and labor for the installation due to the frictional resistance between the inner circumference portion of the through hole 135C and the outer circumference portion of the cylinder 1b.

In this third embodiment, the thickness t3 of the third elastic sheet portion 133C formed on the hub 113 is thinner than the thickness t1 of the first elastic sheet portion 131C (i.e. t3<t1). With such a configuration, it is possible to reduce the frictional resistance between the inner circumference portion of the through hole 135C of the third elastic sheet portion 133C and the outer circumference portion of the cylinder 1b when the cylinder 1b is to be installed to the spring guide 100C. As a result, it is possible to improve the workability upon the installation of the spring guide 100C to the shock absorber 1.

According to the third embodiment described above, the operational advantages similar to those of the above-described first embodiment are afforded. Furthermore, it is possible to more effectively absorb the impact force caused by the broken part of the coil spring 4 exerted to the radially-outside region of the mounting region 110c, and at the same time, it is possible to improve the workability upon the installation of the spring guide 100C to the shock absorber 1.

### Modification of Third Embodiment

In the above-described third embodiment, a description has been given of the spring guide 100C in which the base portion 110 extends toward the outer side of the mounting region 110c in the radial direction and in which the side wall 111 extends upwards at an incline from the radially-outside end portion of the base portion 110 (see FIG. 7B); however, the present invention is not limited thereto. It is possible to omit the side wall 111.

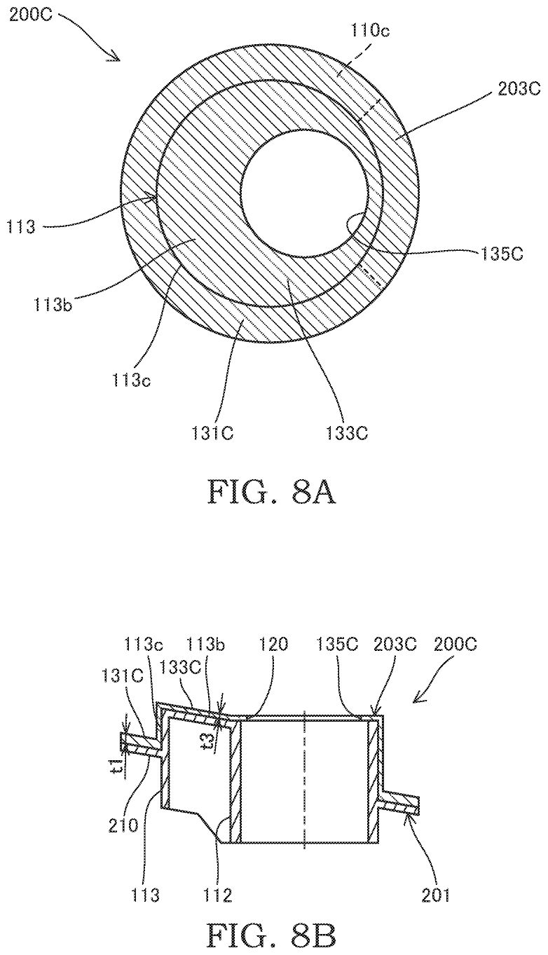

As shown in FIGS. 8A and 8B, in a spring guide 200C according to this modification, in contrast to the main body portion 201 described in the modification of the above-described first embodiment (see FIG. 4B), similarly to the above-described third embodiment, an elastic part 203C having different thicknesses for the respective portions of the main body portion 201 is molded integrally. The elastic part 203C has: the first elastic sheet portion 131C having the thickness t1 and that is integrally molded on the base portion 210; and the third elastic sheet portion 133C having the thickness t3 and that is integrally molded on the hub 113 and the tube portion 112.

### Fourth Embodiment

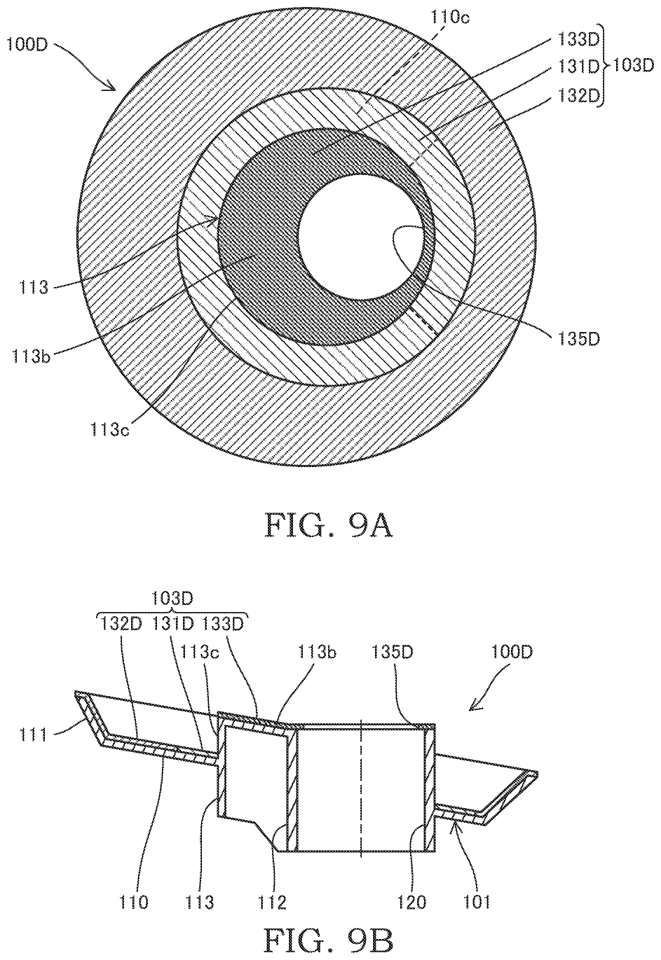

A spring guide 100D according to a fourth embodiment of the present invention will be described with reference to FIGS. 9A and 9B. In the following, differences from the above-mentioned second embodiment will be mainly described, and in the figures, components that are the same as or correspond to the components described in the above-mentioned second embodiment are assigned the same reference numerals and description thereof will be omitted.

In the above-described second embodiment, a description has been given of an example in which the elastic part 103B is formed of a single type of material. In contrast, in the fourth embodiment, a plurality of partial elastic sheet portions (a first elastic sheet portion 131D, a second elastic sheet portion 132D, and a third elastic sheet portion 133D) are formed of mutually different three types of materials, and an elastic part 103D is constituted of three types of the partial elastic sheet portions.

The first elastic sheet portion 131D is integrally molded on the annular-shaped region including the mounting region 110c in the base portion 110. The second elastic sheet portion 132D is integrally molded on the radially-outside region of the mounting region 110c in the base portion 110 and on the upper surface (the inner surface) of the side wall 111. The third elastic sheet portion 133D is integrally molded on the upper surface of the hub 113 and the upper end surface of the tube portion 112.

The second elastic sheet portion 132D is formed so as to cover the entire surface of the upper surface of the base portion 110 and the entire surface of the upper surface (the inner surface) of the side wall 111. Therefore, in the event of a breakage (a fracture) of the coil spring 4, even if the part of the broken coil spring 4 falls and lands on the upper surfaces of the base portion 110 and the side wall 111, it is possible to absorb the impact caused by the broken part with the second elastic sheet portion 132D. As a result, it is possible to prevent the damage of the base portion 110 and the side wall 111.

In a case in which the material forming the second elastic sheet portion 132D is the material having the elastic modulus lower than the material forming the first elastic sheet portion 131D, in the event of the collision of the sharp portion of the broken part of the coil spring 4 with the second elastic sheet portion 132D, the second elastic sheet portion 132D may be deformed largely. Thus, the impact force is not sufficiently absorbed with the second elastic sheet portion 132D and the impact force is transmitted to the main body portion 101 via the second elastic sheet portion 132D, and there is a risk in that the main body portion 101 is damaged.

In contrast, in the fourth embodiment, the second elastic sheet portion 132D is formed of the material having the elastic modulus higher than the material forming the first elastic sheet portion 131D. Thus, even when the sharp portion of the broken part of the coil spring 4 collides with the second elastic sheet portion 132D, the amount of deformation of the second elastic sheet portion 132D is suppressed, and it is possible to effectively absorb the impact force with the second elastic sheet portion 132D. Thus, even when the part of the broken coil spring 4 falls and lands on the base portion 110 and the side wall 111, it is possible to more effectively prevent the damage of the base portion 110 and the side wall 111.

The third elastic sheet portion 133D is formed with a circular through hole 135D, and the cylinder 1b is inserted through the through hole 135D. The third elastic sheet portion 133D is formed so as to cover the entire surface of the upper surface of the hub 113 and the entire surface of the upper end surface of the tube portion 112. Therefore, in the event of a breakage (a fracture) of the coil spring 4, even if a part of the broken coil spring 4 falls and lands on the upper surfaces of the hub 113 and the tube portion 112, it is possible to absorb the impact caused by the broken part with the third elastic sheet portion 133D. As a result, it is possible to prevent the damage of the hub 113 and the tube portion 112.

The through hole 135D of the third elastic sheet portion 133D is formed such that the inner circumference portion thereof comes into direct contact with the outer circumference of the cylinder 1b over the entire circumference. The third elastic sheet portion 133D closes the gap between the cylinder 1b and the insertion hole 120 of the tube portion 112 through which the cylinder 1b is inserted. With such a configuration, it is possible to prevent the extraneous matters such as the sand, the water, and so forth from entering the gap between the cylinder 1b and the insertion hole 120 by the third elastic sheet portion 133D. Therefore, it is possible to prevent the degradation and damage due to the entrance of the extraneous matters into the gap between the outer circumference of the cylinder 1b and the inner circumference of the insertion hole 120.

The third elastic sheet portion 133D is formed of the material having the elastic modulus lower than the material forming the first elastic sheet portion 131D. With such a configuration, even if the spring guide 100D is displaced in the axial direction relative to the cylinder 1b when the shock absorber 1 is operated, the third elastic sheet portion 133D suitably follows the outer circumference of the cylinder 1b. Therefore, during the operation of the shock absorber 1, a state in which the gap between the cylinder 1b and the insertion hole 120 is closed by the third elastic sheet portion 133D is suitably maintained. With such a configuration, compared with a case in which the material forming the third elastic sheet portion 133D has the elastic modulus higher than the material forming the first elastic sheet portion 131D, it is possible to improve the seal performance between the outer circumference of the cylinder 1b and the inner circumference of the insertion hole 120.

According to the fourth embodiment described above, the operational advantages similar to those of the second embodiment are afforded. Furthermore, it is possible to more effectively prevent the damage of the main body portion 101 caused by the collision of the broken part of the broken coil spring 4 with the radially-outside region of the mounting region 110c. In addition, it is possible to further improve the seal performance between the outer circumference of the cylinder 1b and the inner circumference of the insertion hole 120, and it is possible to more effectively prevent the degradation and damage due to the entrance of the extraneous matters into the gap between the outer circumference of the cylinder 1b and the inner circumference of the insertion hole 120.

### Modification of Fourth Embodiment

In the above-described fourth embodiment, a description has been given of the spring guide 100D in which the base portion 110 extends toward the outer side of the mounting region 110c in the radial direction and in which the side wall 111 extends upwards at an incline from the radially-outside end portion of the base portion 110 (see FIG. 9B); however, the present invention is not limited thereto. It is possible to omit the side wall 111.

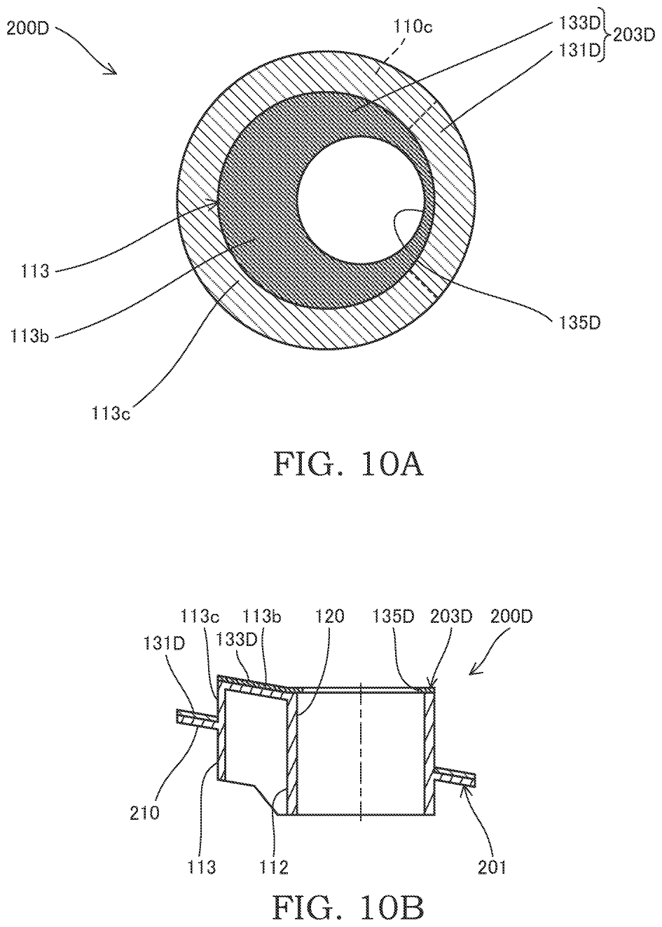

As shown in FIGS. 10A and 10B, in a spring guide 200D according to this modification, in contrast to the main body portion 201 described in the modification of the above-described first embodiment (see FIG. 4B), similarly to the above-described fourth embodiment, the partial elastic sheet portions formed of different materials for the respective portions of the main body portion 201 are molded integrally. An elastic part 203D that is integrally molded on the main body portion 201 has the first elastic sheet portion 131D integrally molded on the base portion 210 and the third elastic sheet portion 133D integrally molded on the hub 113 and the tube portion 112. The third elastic sheet portion 133D is formed of the material having the elastic modulus lower than the material forming the first elastic sheet portion 131D.

Following modifications also fall within the scope of the present invention, and it is also possible to combine the configurations shown in the modifications with the configurations described in the above-described embodiments, to combine the configurations described in the above-described different embodiments, and to combine the configurations described in the following different modifications.

<First Modification>

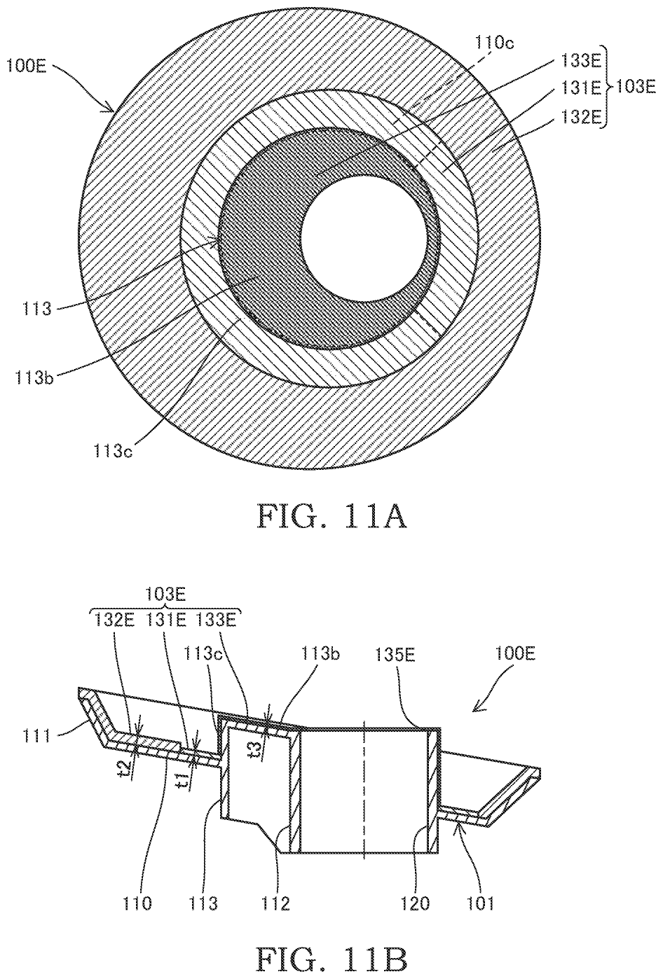

For example, the configuration described in the third embodiment described above may be combined with the configuration described in the fourth embodiment described above. As shown in FIGS. 11A and 11B, an elastic part 103E of a spring guide 100E according to this modification has: a first elastic sheet portion 131E having the thickness t1 that is integrally molded on an annular-shaped region including the mounting region 110c; a second elastic sheet portion 132E having the thickness t2 that is integrally molded on the radially-outside region of the mounting region 110c and on the upper surface (the inner surface) of the side wall 111; and a third elastic sheet portion 133E having the thickness t3 that is integrally molded on the hub 113 and the tube portion 112. The size relationship between the thicknesses t1, t2, and t3 is t3<t1<t2. In addition, the elastic modulus of the second elastic sheet portion 132E is higher than the elastic modulus of the first elastic sheet portion 131E, and the elastic modulus of the third elastic sheet portion 133E is lower than the elastic modulus of the first elastic sheet portion 131E. According to such a modification, the operational advantages similar to those of the third embodiment and the fourth embodiment described above are afforded.

In this modification and the above-described third embodiment, a description has been given of an example in which the size relationship between the thicknesses t1, t2, and t3 is t3<t1<t2; however, the present invention is not limited thereto. The size relationship between the thicknesses t1, t2, and t3 can be changed appropriately in accordance with a specification of the suspension device 10. For example, the thickness t3 of the third elastic sheet portion 133C may be thicker than the thickness t1 of the first elastic sheet portion 131C. In this case, it is possible to effectively absorb the impact force caused by the broken part of the coil spring 4 falling and landing on the upper surfaces of the hub 113 and the tube portion 112 and to effectively prevent the damage of the hub 113 and the tube portion 112.

In addition, the thickness t1 of the first elastic sheet portion 131C may be thicker than the thickness t2 of the second elastic sheet portion 132C. The thickness t1 of the first elastic sheet portion 131C affects on a ride quality of the vehicle on which the suspension device 10 is mounted. By increasing the thickness t1 of the first elastic sheet portion 131C, in a state in which the coil spring 4 is not broken and elastically supports the vehicle body normally, it is possible to sufficiently absorb the force acting on the coil spring 4 from the road surface with the first elastic sheet portion 131C. Thus, it is possible to improve the ride quality of the vehicle on which the suspension device 10 is mounted.

In the above, it is preferable that the thickness t2 of the second elastic sheet portion 132C be set at or higher than the thickness that allows suitable absorption of the impact caused by a fragmented portion of the coil spring 4. With such a configuration, it is possible to improve the ride quality of the vehicle on which the suspension device 10 is mounted and to absorb the impact caused by the broken part of the coil spring 4 with the second elastic sheet portion 132C.

In the above, the thickness t1 of the first elastic sheet portion 131C may not be uniform, and the thickness may be different from place to place. In other words, the size relationship between the thickness t1 of the first elastic sheet portion 131C and the thickness t2 of the second elastic sheet portion 132C may be different from place to place in the first elastic sheet portion 131C. For example, the thickness t1 of the first elastic sheet portion 131C may be changed such that the first elastic sheet portion 131C is formed so as to follow along a shape of the end portion of the coil spring 4 that is seated on the first elastic sheet portion 131C. With such a configuration, it is possible to mount the coil spring 4 stably.

<Second Modification>

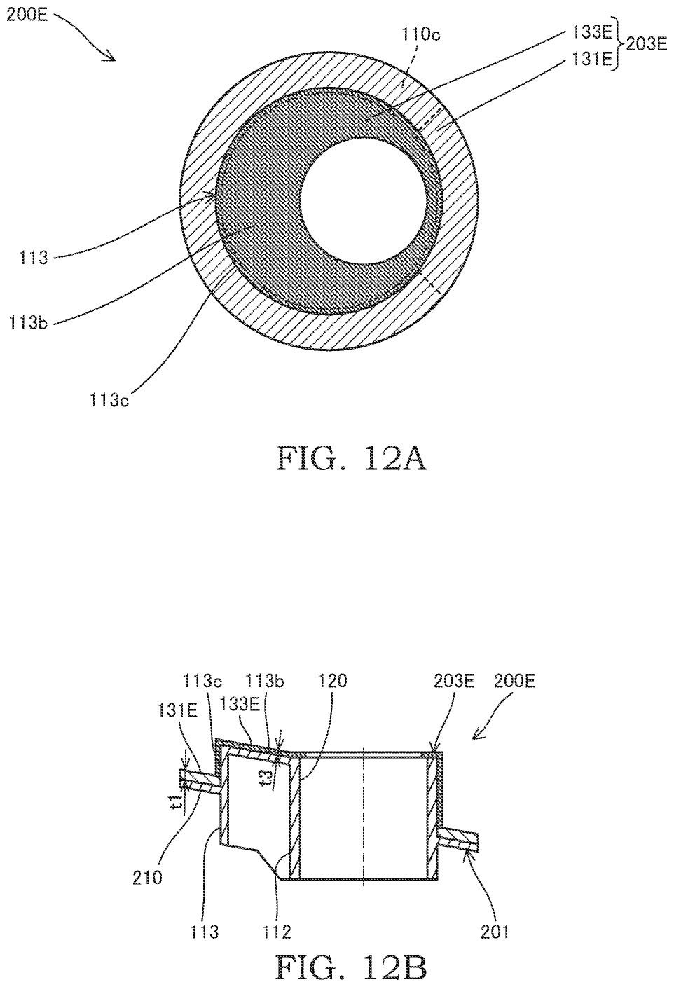

In addition, the configuration described in the modification of the third embodiment described above may be combined with the configuration described in the modification of the fourth embodiment described above. As shown in FIGS. 12A and 12B, an elastic part 203E of a spring guide 200E according to this modification has: the first elastic sheet portion 131E having the thickness t1 and that is integrally molded on the annular-shaped region including the mounting region 110c and the third elastic sheet portion 133E having the thickness t3 and that is integrally molded on the hub 113 and the tube portion 112. The size relationship between the thicknesses t1 and t3 is t3<t1. In addition, the elastic modulus of the third elastic sheet portion 133E is lower than the elastic modulus of the first elastic sheet portion 131E.

In this modification and the above-described fourth embodiment, a description has been given of an example in which the elastic modulus of the second elastic sheet portion 132D is higher than the elastic modulus of the first elastic sheet portion 131D, and the elastic modulus of the third elastic sheet portion 133D is lower than the elastic modulus of the first elastic sheet portion 131D; however, the present invention is not limited thereto. The magnitude relationship of the elastic modulus can be changed appropriately in accordance with the specification of the suspension device 10. For example, the elastic modulus of the third elastic sheet portion 133D may be higher than the elastic modulus of the first elastic sheet portion 131C. In this case, it is possible to effectively absorb the impact force caused by the broken part of the coil spring 4 falling and landing on the upper surfaces of the hub 113 and the tube portion 112 and to effectively prevent the damage of the hub 113 and the tube portion 112.

In addition, the elastic modulus of the first elastic sheet portion 131D may be higher than the elastic modulus of the second elastic sheet portion 132D. The elastic modulus of the first elastic sheet portion 131D affects the ride quality of the vehicle on which the suspension device 10 is mounted. By increasing the elastic modulus of the first elastic sheet portion 131D, it is possible to sufficiently absorb the impact acting on the coil spring 4 with the first elastic sheet portion 131D. Thus, it is possible to improve the ride quality of the vehicle on which the suspension device 10 is mounted. In addition, the elastic modulus of the third elastic sheet portion 133D may be higher than the elastic modulus of the second elastic sheet portion 132D. The elastic modulus of all of the first elastic sheet portion 131D, the second elastic sheet portion 132D, and the third elastic sheet portion 133D may be the same.

<Third Modification>

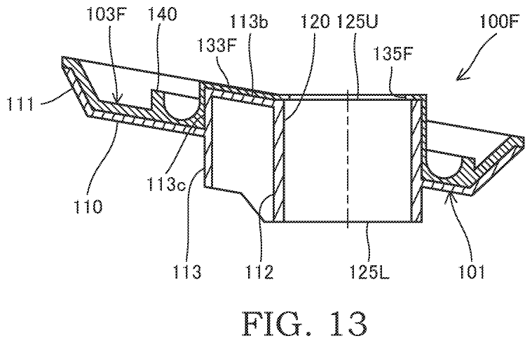

As shown in FIG. 13, a seating portion 140 on which the lower end portion of the coil spring 4 seats may be formed on an elastic part 103F. The seating portion 140 has a curved surface that is curved such that its cross-section follows along the cross-sectional shape of the coil spring 4. The seating portion 140 prevents an outward positional displacement of the lower end portion of the coil spring 4 in the radial direction. With such a configuration, it is possible to hold the coil spring 4 by a spring guide 100F more stably.

<Fourth Modification>

A description has been given of an example in which the base portion 110, 210 of the main body portion 101, 201 has a disc shape; however, the present invention is not limited thereto. The base portion 110, 210 may be a plate having a polygonal shape.

<Fifth Modification>

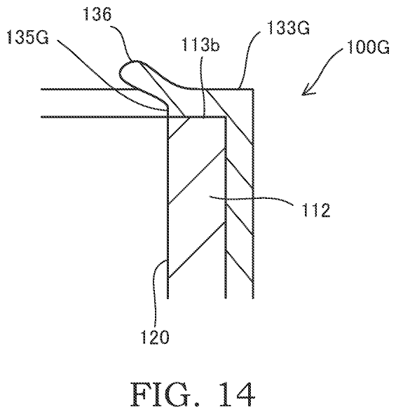

As shown in FIG. 14, a lip 136 provided in a through hole 135G formed in a third elastic sheet portion 133G may be brought into contact with the outer circumference of the cylinder 1b. In other words, the third elastic sheet portion 133G may have the lip 136 that is in contact with the outer circumference of the cylinder 1b of the shock absorber 1. The lip 136 is provided so as to project from the third elastic sheet portion 133G towards the center side of the through hole 135G. The lip 136 is provided over the entire circumference of the through hole 135G. The lip 136 closes the gap between the cylinder 1b and the insertion hole 120 of the tube portion 112 through which the cylinder 1b is inserted.

By providing the lip 136, similarly to the second embodiment, it is possible to prevent the degradation and damage due to the entrance of the extraneous matters into the gap between the outer circumference of the cylinder 1b and the inner circumference of the insertion hole 120.

In addition, with the second embodiment, because the gap between the cylinder 1b and the insertion hole 120 is closed over the entire inner circumferential surface of the third elastic sheet portion 133B, an interference is formed on an inner circumferential surface of the third elastic sheet portion 133B for the cylinder 1b. Thus, when the cylinder 1b is inserted into the insertion hole 120, a strained force fastening the cylinder 1b is generated by the interference of the third elastic sheet portion 133B. The larger the thickness of the third elastic sheet portion 133B is, the larger the strained force becomes. Because the third elastic sheet portion 133B has a relatively large thickness and the region in the axial direction for pressing the cylinder 1b is large, the third elastic sheet portion 133B becomes more resistant to be moved relative to the cylinder 1b due to the large strained force. Thus, there is a risk in that, when the cylinder 1b is to be inserted into the insertion hole 120, a large force is applied to the third elastic sheet portion 133B, and so, the third elastic sheet portion 133B is delaminated from the hub 113.

In contrast, in this modification, the gap between the cylinder 1b and the insertion hole 120 is closed by the lip 136, but not by the third elastic sheet portion 133G. With such a configuration, the region in the axial direction at which the third elastic sheet portion 133G presses the cylinder 1b can be made smaller compared with the second embodiment, and so, the third elastic sheet portion 133G can be moved relative to the cylinder 1b with ease. Thus, the force applied to the third elastic sheet portion 133G when the cylinder 1b is to be inserted through the insertion hole 120 is reduced, and so, it is possible to suppress the delamination between the third elastic sheet portion 133G and the hub 113. The third elastic sheet portion 133G may be the third elastic sheet portion 133B, 133C, 133D, 133E, 133F.

The configurations, operations, and effects of the embodiments of the present invention configured as described above will be collectively described.

The spring guide 100A, 100B, 100C, 100D, 100E, 100F, 200A, 200B, 200C, 200D, 200E is attached to the shock absorber 1, the shock absorber 1 being provided between the vehicle body and the wheel, the spring guide being configured to support the coil spring 4 for elastically supporting the vehicle body, the spring guide including: the main body portion 101, 201 formed of the resin material; and the elastic part 103A, 103B, 103C, 103D, 103E, 103F, 203A, 203B, 203C, 203D, 203E provided between the main body portion 101, 201 and the end portion of the coil spring 4, wherein the elastic part 103A, 103B, 103C, 103D, 103E, 103F, 203A, 203B, 203C, 203D, 203E is formed of the material having the elastic modulus lower than the material forming the main body portion 101, 201, the elastic part being integrally molded on the main body portion 101, 201.

In this configuration, because the main body portion 101, 201 of the spring guide 100A, 100B, 100C, 100D, 100E, 100F, 200A, 200B, 200C, 200D, 200E is formed of the resin material, it is possible to achieve weight reduction compared with a case in which the main body portion 101, 201 is formed of the metal material. In addition, because the elastic part 103A, 103B, 103C, 103D, 103E, 103F, 203A, 203B, 203C, 203D, 203E is integrally molded on the main body portion 101, 201, it is possible to reduce the number of parts compared with a case in which the main body portion 101, 201 and the elastic part 103A, 103B, 103C, 103D, 103E, 103F, 203A, 203B, 203C, 203D, 203E are formed individually as separate parts.

In the spring guide 100A, 100B, 100C, 100D, 100E, 100F, the main body portion 101 has: the disc-shaped base portion 110 having the mounting region 110c for mounting the coil spring 4; and the side wall 111 extending upwards from the radially-outside end portion of the base portion 110, and wherein the elastic part 103A, 103B, 103C, 103D, 103E, 103F has: the first elastic sheet portion 131A, 131B, 131C, 131D, 131E integrally molded on the mounting region 110c in the base portion 110; and the second elastic sheet portion 132A, 132B, 132C, 132D, 132E integrally molded on the radially-outside region of the mounting region 110c in the base portion 110 and on the side wall 111.

In this configuration, the second elastic sheet portion 132A, 132B, 132C, 132D, 132E is integrally molded on the radially-outside region of the mounting region 110c in the base portion 110 and on the side wall 111. Therefore, even if the coil spring 4 is broken and the part of the broken coil spring 4 falls and lands on the base portion 110 and the side wall 111, the impact caused by the broken part of the coil spring 4 can be absorbed with the second elastic sheet portion 132A, 132B, 132C, 132D, 132E, and therefore, it is possible to effectively prevent the damage of the base portion 110 and the side wall 111 of the spring guide 100A, 100B, 100C, 100D, 100E, 100F.

In the spring guide 100C, the thickness t1 of the first elastic sheet portion 131C is thicker than the thickness t2 of the second elastic sheet portion 132C.

In this configuration, in a state in which the coil spring 4 is not broken and elastically supports the vehicle body normally, it is possible to sufficiently absorb the force acting on the coil spring 4 from the road surface with the first elastic sheet portion 131C. Thus, it is possible to improve the ride quality of the vehicle on which the suspension device 10 is mounted.

In the spring guide 100C, 100E, the thickness t2 of the second elastic sheet portion 132C, 132E is thicker than the thickness t1 of the first elastic sheet portion 131C, 131E.

In the spring guide 100D, 100E, the second elastic sheet portion 132D, 132E is formed of the material having the elastic modulus higher than the material forming the first elastic sheet portion 131D, 131E.

With these configurations, even when the part of the broken coil spring 4 falls and lands on the base portion 110 and the side wall 111, it is possible to more effectively prevent the damage of the base portion 110 and the side wall 111.

In the spring guide 100B, 100C, 100D, 100E, 100F, 200B, 200C, 200D, 200E, the main body portion 101, 201 has the disc-shaped base portion 110, 210 configured to mount the lower end portion of the coil spring 4; and the position defining part (the hub 113) provided on the inner side of the coil spring 4 so as to project out from the base portion 110, 210, the position defining part being configured to define the position of the lower end portion of the coil spring 4, and wherein the elastic part 103B, 103C, 103D, 103E, 103F, 203B, 203C, 203D, 203E has: the first elastic sheet portion 131B, 131C, 131D, 131E integrally molded on the base portion 110, 210; and the third elastic sheet portion 133B, 133C, 133D, 133E integrally molded on the position defining part (the hub 113).

In this configuration, the third elastic sheet portion 133B, 133C, 133D, 133E is integrally molded on the position defining part (the hub 113) that is provided on the inner side of the coil spring 4. Therefore, even if the coil spring 4 is broken and the part of the broken coil spring 4 falls and lands on the position defining part (the hub 113), the impact caused by the broken part of the coil spring 4 can be absorbed with the third elastic sheet portion 133B, 133C, 133D, 133E, and therefore, it is possible to effectively prevent the damage of the position defining part (the hub 113) of the spring guide 100B, 100C, 100D, 100E, 100F, 200B, 200C, 200D, 200E.

In the spring guide 100B, 100C, 100D, 100E, 100F, 200B, 200C, 200D, 200E, the main body portion 101, 201 has the cylindrical tube portion 112 through which the cylinder 1b of the shock absorber 1 is inserted, and the third elastic sheet portion 133B, 133C, 133D, 133E is configured to close the gap between the cylinder 1b and the insertion hole 120 of the tube portion 112 through which the cylinder 1b is inserted.

In this configuration, it is possible to prevent the extraneous matters such as the sand, the water, and so forth from entering the gap between the cylinder 1b and the insertion hole 120 by the third elastic sheet portion 133B, 133C, 133D, 133E.

In the spring guide 100B, 100C, 100D, 100E, 100F, 200B, 200C, 200D, 200E, the third elastic sheet portion 133B, 133C, 133D, 133E, 133F has the lip 136, the lip 136 being configured to close the gap between the cylinder 1b and the insertion hole 120 by being brought into contact with the cylinder 1b of the shock absorber 1.

In this configuration, when the cylinder 1b is to be inserted through the insertion hole 120, a less force is applied to the third elastic sheet portion 133B, 133C, 133D, 133E, 133F in the insertion direction of the cylinder 1b. Thus, it is possible to suppress the delamination between the third elastic sheet portion 133B, 133C, 133D, 133E, 133F and the hub 113.

In the spring guide 100C, 100E, 200C, 200E, the thickness t3 of the third elastic sheet portion 133C, 133E is thinner than the thickness t1 of the first elastic sheet portion 131C, 131E.

In this configuration, when the cylinder 1b is installed to the spring guide 100C, 100E, 200C, 200E, it is possible to reduce the frictional resistance between the third elastic sheet portion 133C, 133E and the outer circumference portion of the cylinder 1b. As a result, it is possible to improve the workability upon the installation of the spring guide 100C, 100E for the shock absorber 1.

In the spring guide 100D, 100E, 200D, 200E, the third elastic sheet portion 133D, 133E is formed of the material having the elastic modulus lower than the material forming the first elastic sheet portion 131D, 131E.

In this configuration, even if the spring guide 100D, 100E, 200D, 200E is displaced in the axial direction relative to the cylinder 1b when the shock absorber 1 is operated, it is possible to make the third elastic sheet portion 133D, 133E to suitably follow the outer circumference of the cylinder 1b, and so, it is possible to close the gap between the cylinder 1b and the insertion hole 120 by the third elastic sheet portion 133D, 133E.

The suspension device 10 includes: the above-described spring guide 100A, 100B, 100C, 100D, 100E, 100F, 200A, 200B, 200C, 200D, 200E; the shock absorber 1; the upper mount 2 attached to a tip end of the rod 1a of the shock absorber 1; the coil spring 4 provided between the spring guide 100A, 100B, 100C, 100D, 100E, 100F, 200A, 200B, 200C, 200D, 200E and the upper mount 2; and the metallic supporting portion (the support ring 3) fixed to the cylinder 1b of the shock absorber 1, the supporting portion being configured to support the spring guide 100A, 100B, 100C, 100D, 100E, 100F, 200A, 200B, 200C, 200D, 200E.

In this configuration, because the above-described spring guide 100A, 100B, 100C, 100D, 100E, 100F, 200A, 200B, 200C, 200D, 200E is provided, it is possible to provide the suspension device 10 with which the weight reduction is achieved without increasing the number of parts constituting.

Embodiments of the present invention were described above, but the above embodiments are merely examples of applications of the present invention, and the technical scope of the present invention is not limited to the specific constitutions of the above embodiments.

With respect to the above description, the contents of application No. 2019-095069, with a filing date of May 21, 2019 in Japan, are incorporated herein by reference.

1. A spring guide attached to a shock absorber, the shock absorber being provided between a vehicle body and a wheel, the spring guide being configured to support a coil spring for elastically supporting the vehicle body, and the spring guide comprising:
a main body portion formed of a resin material; and
an elastic part provided between the main body portion and an end portion of the coil spring, wherein
the elastic part is formed of a material having elastic modulus lower than the material forming the main body portion, the elastic part being integrally molded on the main body portion.

2. The spring guide according to claim 1, wherein
the main body portion has:
a disc-shaped base portion having a mounting region for mounting the coil spring; and
a side wall extending upwards from a radially-outside end portion of the base portion, and wherein
the elastic part has:
a first elastic sheet portion integrally molded on the mounting region in the base portion; and
a second elastic sheet portion integrally molded on a radially-outside region of the mounting region in the base portion and on the side wall.

3. The spring guide according to claim 2, wherein
a thickness of the first elastic sheet portion is thicker than a thickness of the second elastic sheet portion.

4. The spring guide according to claim 2, wherein
a thickness of the second elastic sheet portion is thicker than a thickness of the first elastic sheet portion.

5. The spring guide according to claim 2, wherein
the second elastic sheet portion is formed of a material having elastic modulus higher than a material forming the first elastic sheet portion.

6. The spring guide according to claim 1, wherein
the main body portion has:
a disc-shaped base portion configured to mount a lower end portion of the coil spring; and
a position defining part provided on an inner side of the coil spring so as to project out from the base portion, the position defining part being configured to define a position of the lower end portion of the coil spring, and wherein
the elastic part has:
a first elastic sheet portion integrally molded on the base portion; and
a third elastic sheet portion integrally molded on the position defining part.

7. The spring guide according to claim 6, wherein
the main body portion has a cylindrical tube portion through which a cylinder of the shock absorber is inserted, and
the third elastic sheet portion is configured to close a gap between the cylinder and an insertion hole of the tube portion through which the cylinder is inserted.

8. The spring guide according to claim 7, wherein
the third elastic sheet portion has a lip, the lip being configured to close the gap between the cylinder and the insertion hole by being brought into contact with the cylinder of the shock absorber.

9. The spring guide according to claim 7, wherein
a thickness of the third elastic sheet portion is thinner than a thickness of the first elastic sheet portion.

10. The spring guide according to claim 7, wherein
the third elastic sheet portion is formed of a material having elastic modulus lower than the material forming the first elastic sheet portion.

11. A suspension device comprising:
the spring guide according to claim 1;
the shock absorber;
an upper mount attached to a tip end of a rod of the shock absorber;
the coil spring provided between the spring guide and the upper mount; and
a metallic supporting portion fixed to a cylinder of the shock absorber, the supporting portion being configured to support the spring guide.
